(19) United States
(12) Patent Application Publication
(10) Pub. No.: US 2021/0125166 A1
(43) Pub. Date: Apr. 29, 2021

(54) SYSTEMS AND METHODS OF IDENTIFYING A RETAIL ITEM AT A CHECKOUT NODE

(71) Applicant: Toshiba Global Commerce Solutions, Inc., Durham, NC (US)

(72) Inventor: Yevgeni Tsirulnik, Frisco, TX (US)

(73) Assignee: Toshiba Global Commerce Solutions, Inc., Durham, NC (US)

(21) Appl. No.: 17/083,214

(22) Filed: Oct. 28, 2020

Related U.S. Application Data
(60) Provisional application No. 62/927,016, filed on Oct. 28, 2019.

(51) Int. Cl. G06Q 20/20; G06N 3/08; G06K 9/00; G01G 19/00

(52) U.S. Cl. CPC G06Q 20/208; G06Q 20/201; G01G 19/00; G06N 3/08; G06K 9/00624; G06Q 20/202

(57) ABSTRACT

Systems and methods of identifying a retail item at a checkout node are provided. In one exemplary embodiment, during a checkout transaction of a retail item, a method performed by a checkout node comprises selecting at least one of a plurality of retail items predicted by a neural network from at least one of a plurality of acquired images of a retail item positioned on a surface of a scale of the checkout node. Further, the acquired images are captured by a plurality of optical sensors of the checkout node. Each sensor has a different viewing angle towards the surface of the scale and the neural network is trained by a set of images of retail items.

### CROSS REFERENCE TO RELATED APPLICATIONS

This application claims the benefit of U.S. Prov. App. No. 62/927,016, filed Oct. 28, 2019, which is hereby incorporated by reference as if fully set forth herein.

### FIELD OF DISCLOSURE

The present disclosure relates generally to the field of retail checkout, and in particular to systems and methods of identifying a retail item at a checkout node.

### BACKGROUND

The high-volume retail segment is quickly moving towards self-service solutions for the retail checkout process. One of the challenges for shoppers adopting or choosing to use self-service solutions is the challenge in finding retail items during the look-up menu process via a user interface terminal. As such, retailers are looking for ways to improve the customer experience with a self-checkout service so as to increase its use.

In one example, retail item recognition solutions ease the look-up process performed by customers, resulting in improved customer experience. However, the current solutions suffer from implementation defects such as poor positioning of a camera to acquire images of the retail item as well as overall solution accuracy. Further, the current solutions use either a standard look-up menu or recognition technology based on a single camera embedded in the scanner scale. Those solutions that utilize a single camera in the scanner scale have a limited viewing angle of the retail item placed on the scale. Further, other solutions having a single camera above or to the side of the scale are prone to an obstructed view such as from a user. In such instances, a hindered view would then require the use of the standard look-up menu, resulting in a poor customer experience.

Accordingly, there is a need for improved techniques for identifying retail items at a checkout node. In addition, other desirable features and characteristics of the present disclosure will become apparent from the subsequent detailed description and embodiments, taken in conjunction with the accompanying figures and the foregoing technical field and background.

The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

Briefly described, embodiments of the present disclosure relate to systems and methods of identifying retail items at a checkout node. According to one aspect, a method performed by a checkout node comprises, during a checkout transaction of a retail item, selecting at least one of a plurality of retail items predicted by a neural network from at least one of a plurality of acquired images of the retail item positioned on a surface of a scale of the checkout node. Further, the acquired images are captured by a plurality of optical sensors of the checkout node, with each sensor having a different viewing angle towards the surface of the scale. Also, the neural network is trained by a set of images of retail items.

According to another aspect, the method further includes sending, to the neural network, the acquired images. The method also includes receiving, from the neural network, for each acquired image, an indication of one or more predicted retail items and their corresponding confidence levels. In addition, the method includes selecting the at least one of the plurality of retail items based on the one or more predicted retail items and their corresponding confidence levels.

According to another aspect, the step of selecting includes selecting those predicted retail items of the acquired images that have a confidence level above a predetermined confidence threshold.

According to another aspect, the step of selecting includes determining which acquired image corresponds to the predicted retail item having the highest confidence level to obtain the selected image. Further, the method includes selecting those predicted retail items of the selected image that have a confidence level above a predetermined confidence threshold.

According to another aspect, the predetermined confidence threshold corresponds to at least a 50% confidence level.

According to another aspect, the predetermined confidence threshold corresponds to at least an 80% confidence level.

According to another aspect, the predetermined confidence threshold corresponds to at least a 90% confidence level.

According to another aspect, the predetermined confidence threshold corresponds to at least a 95% confidence level.

According to another aspect, the method includes obtaining an indication to initiate a checkout transaction of a retail item that requires a weight measurement by the scale. Further, the method includes determining to initiate the checkout transaction of the retail item based on the initiate indication. The method also includes acquiring images captured by each optical sensor.

According to another aspect, the method includes receiving, from a user interface terminal of the checkout node, the indication to initiate the checkout transaction.

According to another aspect, the method includes obtaining an indication of a certain retail item that is identified as the retail item for the checkout transaction. The method also includes determining that the identified retail item is one of the predicted retail items.

According to another aspect, the method includes receiving, from a user interface terminal of the checkout node, the indication of the certain retail item.

According to another aspect, the method includes sending, to a user interface terminal, an indication that the identified retail item is one of the predicted retail items responsive to determining that the identified retail item is one of the predicted retail items.

According to another aspect, the indication of the certain retail item corresponds to a price look-up (PLU) code.

According to another aspect, the method includes obtaining, from the scale, an indication of a weight measurement of the retail item placed on the scale. Further, the step of acquiring the images is responsive to said obtaining the weight measurement.

According to another aspect, the step of obtaining the weight measurement is responsive to determining that the retail item has been stably placed on a surface of the scale.

According to another aspect, at least one sensor is positioned above the surface of the scale with a perpendicular viewing angle relative to the surface of the scale.

According to another aspect, at least one sensor is positioned away from the scale with an acute viewing angle relative to the surface of the scale.

According to another aspect, the acute viewing angle is in a range from 0 to 45 degrees.

According to another aspect, the acute viewing angle is in a range from 15 to 30 degrees.

According to another aspect, at least one sensor is positioned below the surface of the scale and operable to capture an image of the retail placed on the surface of the scale through a transparent or translucent portion of that surface.

According to another aspect, at least one sensor is a camera.

According to another aspect, at least one sensor is an infrared sensor.

According to another aspect, the neural network is co-located with the checkout node.

According to another aspect, a first network node (e.g., server) includes the neural network and provides local network access to the neural network to the checkout node and other co-located checkout nodes.

According to another aspect, the method includes sending, to a second network node (e.g., server) that is operatively coupled to the checkout node via a remote network, at least one acquired image. Further, the second network node is operable to determine whether to include the at least one acquired image to the set of training images based on the confidence level of those acquired images.

According to another aspect, the method includes receiving, from a second network node that provides remote network access to a plurality of checkout nodes, the set of training images. Further, the method includes training the neural network by the set of training images.

According to one aspect, a checkout node is configured to select, during a checkout transaction of a retail item, at least one of a plurality of retail items predicted by a neural network from at least one of a plurality of acquired images of the retail item positioned on a surface of a scale of the checkout node. Further, the acquired images are captured by a plurality of optical sensors of the checkout node. Each sensor has a different viewing angle towards the retail item placed on the surface of the scale. In addition, the neural network is trained by a set of images of retail items.

According to one aspect, a checkout node comprises a processor and a memory with the memory containing instructions executable by the processor whereby the checkout node is configured to select, during a checkout transaction of a retail item, at least one of a plurality of retail items predicted by a neural network from at least one of a plurality of acquired images of the retail item positioned on a surface of a scale of the checkout node. Further, the acquired images are captured by a plurality of optical sensors of the checkout node. Each sensor has a different viewing angle towards the retail item placed on the surface of the scale. In addition, the neural network is trained by a set of images of retail items.

According to one aspect, a computer program product is stored in a non-transitory computer readable medium for controlling a checkout node. Further, the computer program product comprises software instructions which, when run on the checkout node, cause the checkout node to select, during a checkout transaction of a retail item, at least one of a plurality of retail items predicted by a neural network from at least one of a plurality of acquired images of the retail item positioned on a surface of a scale of the checkout node. Further, the acquired images are captured by a plurality of optical sensors of the checkout node. Each sensor has a different viewing angle towards the retail item placed on the surface of the scale. In addition, the neural network is trained by a set of images of retail items.

According to another aspect, a carrier contains the computer program with the carrier being one of an electronic signal, optical signal, radio signal, or computer readable storage medium.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system of identifying retail items at a checkout node in accordance with various aspects as described herein.

FIG. 2 illustrates one embodiment of a checkout node in accordance with various aspects as described herein.

FIGS. 3A-B illustrate other embodiments of a checkout node in accordance with various aspects as described herein.

FIGS. 4A-C illustrate embodiments of a method of identifying retail items at a checkout node in accordance with various aspects as described herein.

FIG. 5 illustrates another embodiment of a checkout node in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

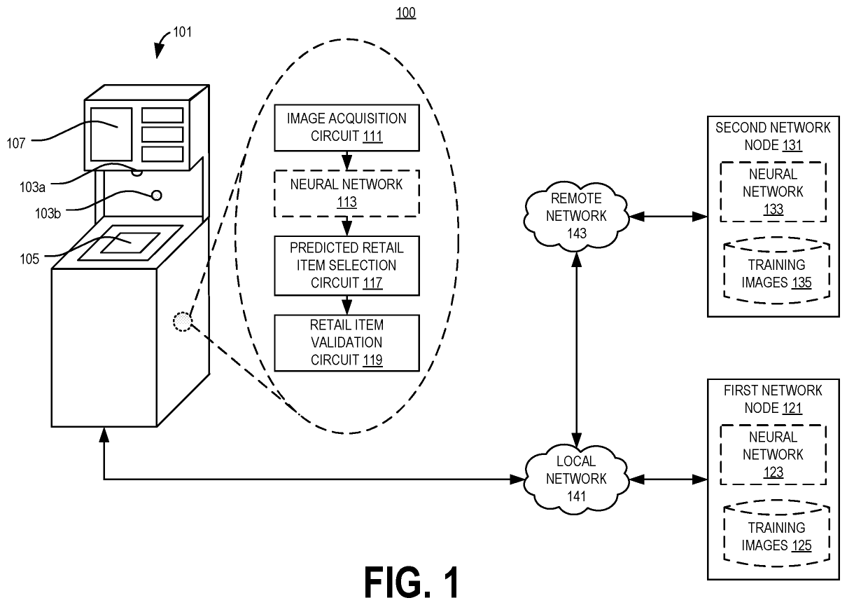

In this disclosure, systems and methods of identifying retail items at a checkout node are provided. For example, FIG. 1 illustrates one embodiment of a system 100 of identifying retail items at a checkout node 101 in accordance with various aspects as described herein. In FIG. 1, the system 100 includes the checkout node 101, a first network node 121 that is communicatively coupled to the checkout node 101 via a local network 141 and a second network node 131 that is also communicatively coupled to the checkout node 101 via a remote network 143 (e.g., Internet). Each of the first and second network nodes 121, 131 may also include a neural network that is accessible by the checkout node 101. The checkout node 101 includes a plurality of optical devices 103a-b, a scale 105, and a user interface terminal 107. Further, the checkout node 101 may include a co-located neural network 113. As one of the advantages of the embodiments described herein is to assist consumers with identifying retail items during self-checkout, it is important that the neural network provides real-time predictions of retail items from acquired images. As such, a skilled artisan would recognize that the time required for network communications between the checkout node 101 and a neural network may require that the neural network be co-located with or physically proximate to the checkout node 101 (e.g., the neural network 113) or accessible from a network node on a local network (e.g., the first network node 121 via the local network 141). However, as the speed of network communications continues to increase, the time required for communications between the checkout node 101 and a neural network accessible from a network node on a remote network (e.g., the second network node 131 via the remote network 143) may become acceptable. In one definition, a local network is a computer network that interconnects computers within a limited area such as a store, residence, school, laboratory, university campus or office building. In another definition, a local network is a local area network (LAN) that interconnects computers within a limited area such as a retail store, residence, school, laboratory, university campus, office building, or the like. In one definition, a remote network is a wide area network (WAN) having computer nodes spanning geographical regions, countries, or the world (e.g., Internet). A retail item refers to a good that is sold directly to a consumer or an end user such as a produce item, floral item, meat item, seafood item, dairy item, health and beauty item, household item, pharmacy item, another item sold in retail, and the like.

In operation, during a checkout transaction of a retail item, the checkout node 101 obtains an indication to initiate the checkout transaction of the retail item that requires a weight measurement by the scale 105. Further, an image acquisition circuit 111 of the checkout node 101 acquires images captured by the optical sensors 103a-b with each sensor having a different viewing angle towards the retail item placed on the surface of the scale 105. As shown in FIG. 1, the optical sensor 103a has a viewing angle directly above the surface of the scale 105. Further, the optical sensor 103b has an acute viewing angle behind and to the side of the scale 105. By acquiring images from optical sensors 103a-b having different viewing angles, the checkout node 101 is able, for instance, to determine which acquired image represents one or more predicted retail items having a higher confidence level (e.g., at least 50% confidence). An acquired image that represents a predicted retail item(s) having a lower confidence level (e.g., less than 50% confidence) may be the result of a user of the checkout node 101 blocking or partially blocking a line of sight from the corresponding optical sensor 103a,b to the retail item positioned on the scale, optical interference caused by a transparent or translucent plastic bag holding the retail item, or the like.

In FIG. 1, the checkout node 101 sends, to a neural network, the acquired images. As previously mentioned, this neural network may be the co-located neural network 113, the neural network 123 accessed via the local network 141, or even the neural network 133 accessed via the remote network 143 (e.g., Internet). In response, the checkout node 101 receives, from the neural network, an indication of one or more predicted retail items and their corresponding confidence levels. A predicted retail item selection circuit 117 of the checkout node 101 then selects at least one of the predicted retail items based on the confidence levels. In one example, the predicted retail item selection circuit 117 selects those predicted retail items of the acquired images that have a confidence level greater than a predetermined confidence level. In another example, the selection circuit 117 determines which image corresponds to the predicted retail items having the highest confidence level. The selection circuit 117 then selects the predicted retail items for that image. The checkout node 101 may also obtain an indication of a certain retail item that is identified as the retail item for the check transaction. In one example, the consumer selects the certain retail item on the user interface terminal 107, with this selection being represented by the indication of the certain retail item. Accordingly, a retail validation circuit 119 of the checkout node 101 determines whether the identified retail item is one of the predicted retail items and then sends, to the user interface terminal 107, an indication of whether the identified retail item matches one of the predicted retail item(s).

In another embodiment, the checkout node 101 also obtains a weight of the retail item positioned on the scale 105. The checkout node 101 then sends, to a neural network, the acquired images and the weight of the retail item positioned on the scale 105. The neural network predicts one or more retail items and its corresponding confidence level based on the acquired images, the weight of the retail item, and the set of training images of retail items. The neural network then sends, to the checkout node 101, an indication of one or more predicted retail items and its corresponding confidence level. In response, the checkout node 101 receives, from the neural network, the indication of the one or more predicted retail items and its corresponding confidence level.

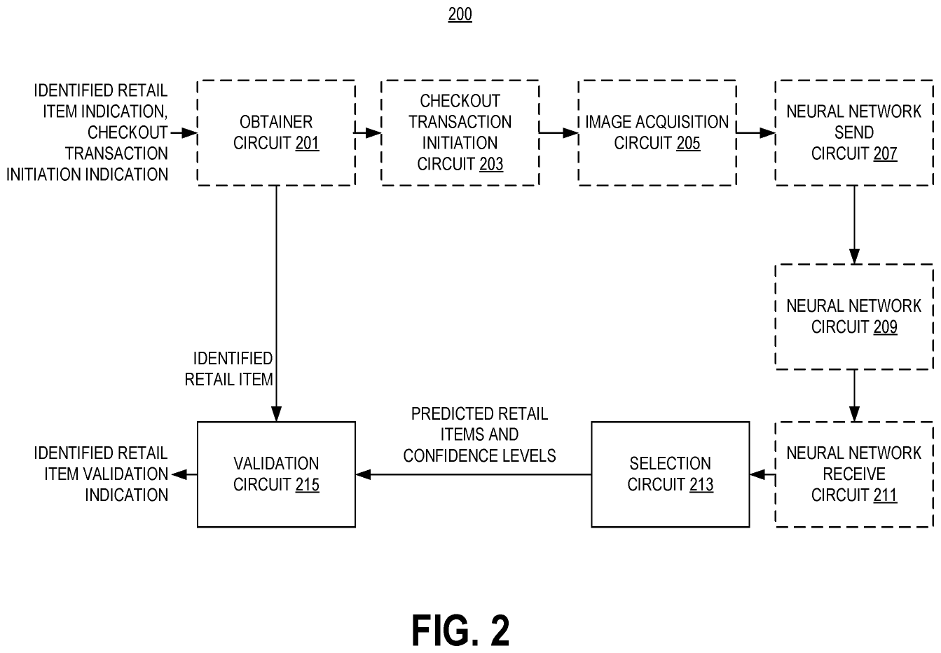

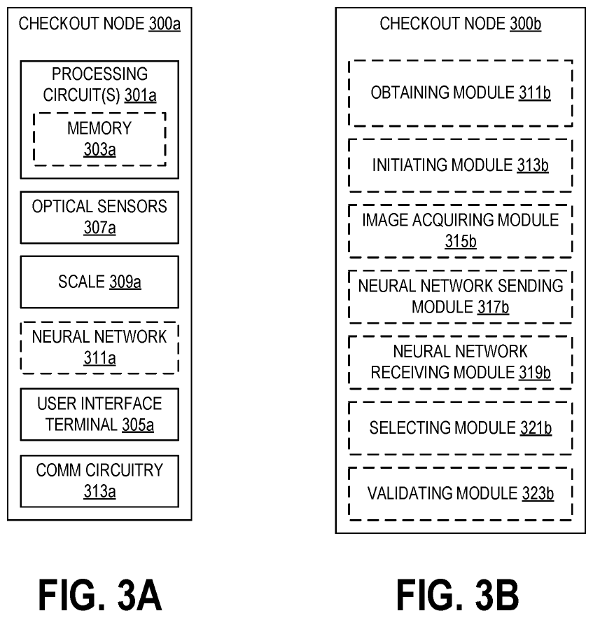

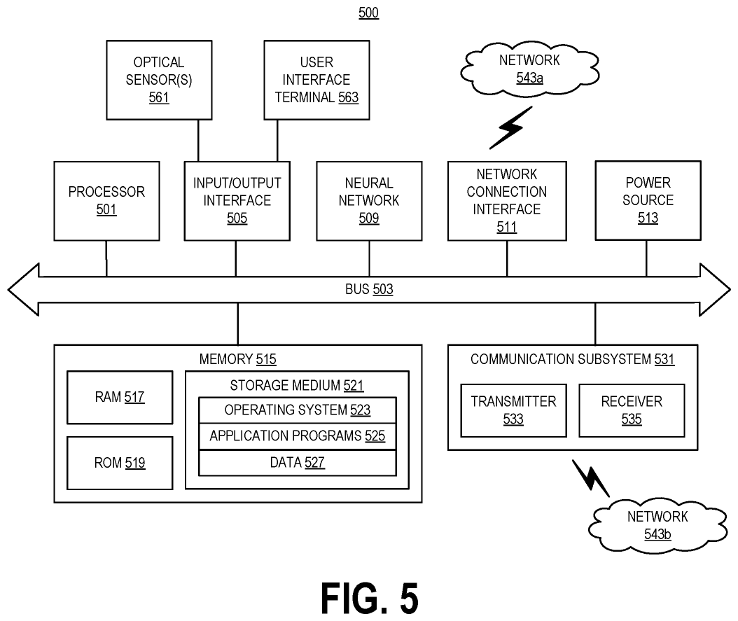

FIG. 2 illustrates one embodiment of a checkout node 200 in accordance with various aspects as described herein. In FIG. 2, the checkout node 200 implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) herein) may include for instance: an obtainer circuit 201 operable to obtain an indication to initiate a checkout transaction of a retail item that requires a weight measurement by a scale; a checkout transaction initiation circuit 203 operable to determine to initiate the checkout transaction of the retail item based on the initiate checkout transaction indication; an image acquisition circuit 205 operable to acquire images captured by a plurality of optical sensors with each sensor having a different viewing angle towards the retail item placed on the surface of the scale ; a neural network send circuit 207 operable to send, to a neural network circuit 209 that is trained by a set of images of retail items, the acquired images; the neural network circuit 209 operable to predict one or more retail items and its corresponding confidence level based on the acquired images and the set of training images of retail items; a neural network receive circuit 211 operable to receive, from the neural network circuit 209, for each acquired image, an indication of one or more predicted retail items and their corresponding confidence levels; a selection circuit 213 operable to select at least one of the plurality of retail items predicted by the neural network circuit 209 based on the one or more predicted retail items and their corresponding confidence levels; and a validation circuit 215 operable to validate whether the identified retail item is one of the predicted retail items and send, to a user interface terminal of the checkout node 200, an indication of whether the identified retail item matches one of the predicted retail item(s).

FIGS. 3A-B illustrate other embodiments of a checkout node 300a-b in accordance with various aspects as described herein. In FIG. 3A, the checkout node 300a may include processing circuitry 301a that is operably coupled to one or more of the following: user interface terminal 305a, optical sensor 307a, weight scale 309a, neural network 311a, communications circuitry 313a, the like, or any combination thereof. The communication circuitry 313a is configured to transmit and/or receive information to and/or from one or more other nodes via any communication technology. The processing circuitry 301a is configured to perform processing described herein, such as by executing instructions stored in memory 303a. The processing circuitry 303a in this regard may implement certain functional means, units, or modules.

In FIG. 3B, the checkout node 300b implements various functional means, units, or modules (e.g., via the processing circuitry 301a in FIG. 3A, via the processing circuitry 501 in FIG. 5, via software code, or the like). In one embodiment, these functional means, units, or modules (e.g., for implementing the method(s) herein) may include for instance: an obtaining module 311b for obtaining an indication to initiate a checkout transaction of a retail item that requires a weight measurement by a scale; an initiating module 313b for determining to initiate the checkout transaction of the retail item based on the initiate checkout transaction indication; an image acquiring module 315b for acquiring images captured by a plurality of optical sensors with each sensor having a different viewing angle towards the retail item placed on the surface of the scale ; a neural network sending module 317b for sending, to a neural network circuit that is trained by a set of images of retail items, the acquired images; a neural network receiving module 319b for receiving, from the neural network circuit, for each acquired image, an indication of one or more predicted retail items and their corresponding confidence levels; a selecting module 321b for selecting at least one of the plurality of retail items predicted by the neural network based on the one or more predicted retail items and their corresponding confidence levels; and a validating module 323b for validating whether the identified retail item is one of the predicted retail items and send, to a user interface terminal of the checkout node 300b, an indication of whether the identified retail item matches one of the predicted retail item(s).

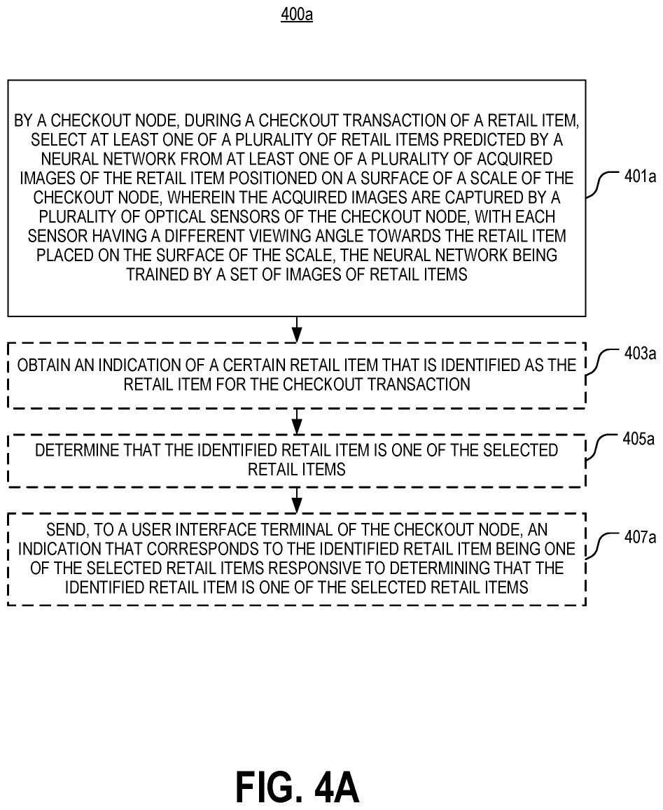

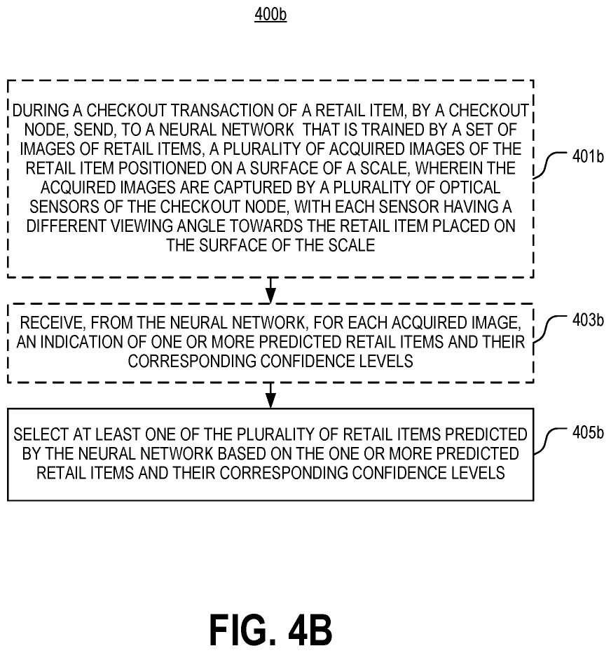

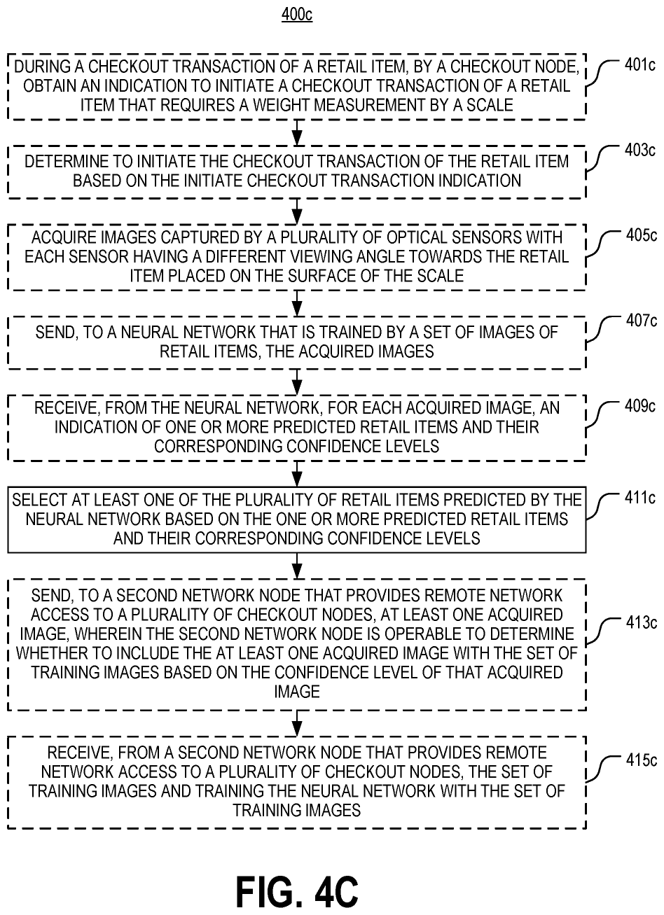

FIGS. 4A-C illustrate embodiments of a method 400a-c of identifying retail items at a checkout node in accordance with various aspects as described herein. In FIG. 4A, the method 400a may start, for instance, at block 401a where it includes, during a checkout transaction of a retail item (e.g., fruit, vegetable, packaged item, or the like) by a checkout node, selecting at least one of a plurality of retail items predicted by a neural network from at least one of a plurality of acquired images of the retail item positioned on a surface of a weight scale of the checkout node. Further, the acquired images are captured by a plurality of optical sensors (e.g., cameras, infrared sensors, or the like) of the checkout node. Each sensor has a different viewing angle towards the retail item placed on the surface of the scale. In one example, at least one sensor is positioned over the surface of the scale so that the sensor has a viewing angle towards the top of the retail item placed on the scale. In another example, at least one sensor is positioned so that the sensor has a viewing angle towards the side of a retail item placed on the scale. In yet another example, at least one sensor is positioned below the scale so that the sensor has a viewing angle towards the bottom of a retail item placed on the scale.

In FIG. 4A, the neural network is trained by a set of images of retail items. In one example, the set of training images may be images of predetermined retail items or retail items having high confidence levels (e.g., >90% confidence, >95% confidence, >98% confidence, or the like). At block 403a, the method 400a may include obtaining an indication of a certain retail item (e.g., a certain fruit, a certain vegetable, a certain package item, or the like) that is identified as the retail item for the checkout transaction. Further, at block 405a, the method 400a may include determining that the identified retail item is one of the selected retail items. The method 400a may include sending, to a user interface terminal of the checkout node, an indication that corresponds to the identified retail item being one of the selected retail items responsive to determining that the identified retail item is one of the selected retail items.

In FIG. 4B, the method 400b may start, for instance, at block 401b where it may include, during a checkout transaction of a retail item by a checkout node, sending, to a neural network that is trained by a set of images of retail items, a plurality of acquired images of the retail item positioned on a surface of a scale of the checkout node. At block 403b, the method 400b may include receiving, from the neural network, for each acquired image, an indication of one or more predicted retail items and their corresponding confidence levels. Further, the method 400b includes selecting at least one of the plurality of retail items predicted by the neural network based on the one or more predicted retail items and their corresponding confidence levels, as referenced at block 405b.

In FIG. 4C, the method 400c may start, for instance, at block 401c where it may include, during a checkout transaction of a retail item by a checkout node, obtaining an indication to initiate a checkout transaction of a retail item that requires a weight measurement by a scale of the checkout node. At block 403c, the method 400c may include determining to initiate the checkout transaction of the retail item based on the initiate checkout transaction indication. Further, the method 400c may include acquiring images captured by a plurality of optical sensors with each sensor having a different viewing angle towards the retail item placed on the surface of the scale, as referenced by block 405c. The method 400c may also include sending, to a neural network that is trained by a set of images of retail items, the acquired images, as referenced by block 407c. At block 409c, the method 400c may include receiving, from the neural network, for each acquired image, an indication of one or more predicted retail items and their corresponding confidence levels. At block 411c, the method 400c includes selecting at least one of the plurality of retail items predicted by the neural network based on the one or more predicted retail items and their corresponding confidence levels. In addition, the method 400c may include sending, to a second network node that provides remote network access to a plurality of checkout nodes, at least one acquired image, wherein the second network node is operable to determine whether to include the at least one acquired image with the set of training images based on the confidence level of that acquired image. At block 415c, the method 400c may include receiving, from a second network node that provides remote network access to a plurality of checkout nodes, the set of training images and training the neural network with the set of training images.

FIG. 5 illustrates another embodiment of a checkout node 500 in accordance with various aspects as described herein. In FIG. 5, checkout node 500 includes processing circuitry 501 that is operatively coupled to input/output interface 505, neural network circuit 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain checkout nodes may utilize all of the components shown in FIG. 5, or only a subset of the components. The level of integration between the components may vary from one checkout node to another checkout node. Further, certain checkout nodes may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. The checkout node 500 may be configured to use an output device via input/output interface 505. An output device may use the same type of interface port as an input device. For example, a USB port may be used to provide input to and output from the checkout node 500. The output device may be a speaker, a sound card, a video card, a display, a monitor, a printer, an actuator, an emitter, a smartcard, another output device, or any combination thereof. The checkout node 500 may be configured to use an input device via input/output interface 505 to allow a user to capture information into the checkout node 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, an infrared sensor, a proximity sensor, another like sensor, or any combination thereof. For example, the input device may be an optical sensor and an infrared sensor.

In FIG. 5, the neural network 509 may be configured to learn to perform tasks by considering examples. In one example, the neural network 509 may learn to identify images that contain certain elements such as retail items. The network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as a retail item selection program, a widget or gadget engine or another application, and a data file 527. The storage medium 521 may store, for use by the checkout node 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the checkout node 500 to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

In FIG. 5, the processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another checkout node capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the checkout node 500.

The features, benefits and/or functions described herein may be implemented in one of the components of the checkout node 500 or partitioned across multiple components of the checkout node 500. Further, the features, benefits, and/or functions described herein may be implemented in any combination of hardware, software or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or network types for illustrative purposes, but the embodiments are similarly applicable in other contexts and/or network types not explicitly described.

In one embodiment, a method performed by a checkout node includes identifying retail items to assist shoppers with looking up retail items at self-checkout. This method utilizes two camera sensors operating together and controlled by a processor board. Each camera sensor provides different line-of-sight angles to the surface of the scale for capturing images of the retail item positioned on the scale. This use of multiple camera sensors overcomes the defects of using a single camera sensor that experiences an obstructed line-of-sight to the surface of the scale, twists or other defects of a bag (e.g. a transparent or translucent bag such as a produce bag), unfavorable placement of the retail item on the scale, or the like. This embodiment may be utilized to assist a cashier in a full-service lane, a shopper at a self-checkout lane, a self-weigh smart shelf or pad for frictionless shopping, or the like. In operation, when a retail item is placed on the scanner/scale and a search is selected on the user interface terminal, the method includes identifying the retail item based on images acquired from a camera placed to the side of the scale and a camera above the scale. The method includes applying neural networks to identify one or more retail items and their confidence levels. The method including generating a list of retail items predicted by the neural network and their confidence levels for this identification. The method then includes comparing the confidence levels of the predicted retail items from images of the two cameras to determine that predicted retail item having the highest confidence level.

In another embodiment, the method includes comparing the confidence levels of the predicted retail items for the acquired images to determine which image corresponds to one or more predicted retail items having the highest confidence levels.

In another embodiment, the neural network is co-located with the checkout node.

In another embodiment, the neural network is located in a network node that is accessible by a plurality of co-located checkout nodes via a local network.

In one embodiment, a method includes identifying a retail item placed on the scale in order to compare the identified retail item to a retail item selected during the standard retail item look-up process such as performed on a user interface terminal. This method provides improved loss prevention over the improper selection of a retail item during this lookup process. In operation, when a shopper places a retail item on the scanner/scale and the shopper chooses to look-up the retail item such as via a user interface terminal or to enter the price look-up (PLU) code, the method includes acquiring images of the retail item placed on the scale from two cameras to recognize the retail items. Further, the method includes determining those predicted retail items that are above a predefined confidence level and then comparing those predicted retail items with the retail item that was selected or entered through the look-up process. If the retail item selected is on the list of these predicted retail items, then the process continues as normal. If not, then an intervention is triggered. This method performs, among other things, the use case when a shopper places a retail item on the scanner/scale but selects a retail code for a less expensive retail item or a different retail item.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method performed by a checkout node, comprising:
during a checkout transaction of a retail item, selecting at least one of a plurality of retail items predicted by a neural network from at least one of a plurality of acquired images of the retail item positioned on a surface of a scale of the checkout node, wherein the acquired images are captured by a plurality of optical sensors of the checkout node, with each sensor having a different viewing angle towards the surface of the scale, the neural network being trained by a set of images of retail items.

2. The method of claim 1, further comprising:
sending, to the neural network, the acquired images;
receiving, from the neural network, for each acquired image, an indication of one or more predicted retail items and their corresponding confidence levels; and
wherein said selecting is based on the one or more predicted retail items and their corresponding confidence levels.

3. The method of claim 2, wherein said selecting includes:
selecting those predicted retail items of the acquired images that have a confidence level above a predetermined confidence threshold.

4. The method of claim 2, further comprising:
determining which acquired image corresponds to the predicted retail item having the highest confidence level to obtain the selected image; and
wherein said selecting includes selecting those predicted retail items of the selected image that have a confidence level above a predetermined confidence threshold.

5. The method of claim 1, further comprising:
obtaining an indication to initiate a checkout transaction of a retail item that requires a weight measurement by the scale;
determining to initiate the checkout transaction of the retail item based on the initiate indication; and
acquiring images captured by each optical sensor.

6. The method of claim 1, further comprising:
obtaining an indication of a certain retail item that is identified as the retail item for the checkout transaction; and
determining that the identified retail item is one of the predicted retail items.

7. The method of claim 6, wherein said obtaining the certain retail item indication includes:
receiving, from a user interface terminal of the checkout node, the indication of the certain retail item; and
sending, to a user interface terminal, an indication that the identified retail item is one of the predicted retail items responsive to determining that the identified retail item is one of the predicted retail items.

8. The method of claim 6, wherein the indication of the certain retail item corresponds to a price look-up (PLU) code.

9. The method of claim 1, further comprising:
obtaining, from the scale, an indication of a weight measurement of the retail item placed on the surface of the scale; and
wherein said acquiring the images is responsive to said obtaining the weight measurement.

10. The method of claim 9, wherein said obtaining the weight measurement indication is responsive to determining that the retail item has been stably placed on the surface of the scale.

11. The method of claim 1, wherein at least one sensor is positioned above the surface of the scale with a perpendicular viewing angle relative to the surface of the scale.

12. The method of claim 1, wherein at least one sensor is positioned away from the scale with an acute viewing angle relative to the surface of the scale.

13. The method of claim 1, wherein at least one sensor is positioned below the surface of the scale and operable to capture an image of the retail item placed on the surface of the scale through a transparent or translucent portion of that surface.

14. The method of claim 1, wherein at least one sensor is a camera.

15. The method of claim 1, wherein at least one sensor is an infrared sensor.

16. The method of claim 1, wherein the neural network is co-located with the checkout node.

17. The method of claim 1, wherein a first network node includes the neural network and provides local network access to the neural network by the checkout node.

18. The method of claim 1, further comprising:
sending, to a second network node that provides remote network access to a plurality of checkout nodes, at least one acquired image, wherein the second network node is operable to determine whether to include the at least one acquired image to the set of training images based on the confidence level of those acquired images.

19. The method of claim 1, further comprising:
receiving, from a second network node that provides remote network access to a plurality of checkout nodes, the set of training images; and
training the neural network by the set of training images.

20. A checkout node, comprising:
a processor and a memory, the memory containing instructions executable by the processor whereby the checkout node is configured to:
select, during a checkout transaction of a retail item, at least one of a plurality of retail items predicted by a neural network from at least one of a plurality of acquired images of the retail item positioned on a surface of a scale of the checkout node, wherein the acquired images are captured by a plurality of optical sensors of the checkout node, with each sensor having a different viewing angle towards the retail item placed on the surface of the scale, the neural network being trained by a set of images of retail items.
